(19) United States
(12) Patent Application Publication
(10) Pub. No.: US 2025/0237877 A1
(43) Pub. Date: Jul. 24, 2025

(54) OPTICAL SUPPORT SYSTEM FOR AUGMENTED REALITY GLASSES

(71) Applicant: Snap Inc., Santa Monica, CA (US)

(72) Inventor: Oliver William Maton, Oxford (GB)

(21) Appl. No.: 19/011,126

(22) Filed: Jan. 6, 2025

Related U.S. Application Data
(60) Provisional application No. 63/624,173, filed on Jan. 23, 2024.

(51) Int. Cl. G02B 27/01; G02B 27/28; G02B 27/62

(52) U.S. Cl. CPC G02B 27/0176; G02B 27/0172; G02B 27/283; G02B 27/62; G02B 2027/0114; G02B 2027/0169; G02B 2027/0178; G02B 2027/0198

(57) ABSTRACT

The present disclosure relates to an optical support system for augmented reality (AR) eyewear, which includes a monocular chassis designed to integrate and precisely align optical components such as a projector, waveguide, and various other components. The monocular chassis is characterized by its monocoque construction, incorporating integrated alignment features that facilitate the accurate positioning of the optical elements for optimal device performance. In some examples, the chassis is constructed from materials with a low coefficient of thermal expansion and is manufactured using injection molding techniques, making it suitable for mass production. The design allows for the decoupling of the projector from stresses imparted by the eyewear frame, seeking to ensure the integrity of the optical path. Additionally, the waveguide is secured to the chassis using pressure-sensitive adhesive tape, providing a flexible yet strong bond. Disclosed examples offer a robust, precise, and scalable solution for the production of high-quality AR eyewear.

### CLAIM OF PRIORITY

This patent application claims the benefit of priority to Maton, U.S. Provisional Patent Application Ser. No. 63/624,173, entitled “OPTICAL SUPPORT SYSTEM FOR AUGMENTED REALITY GLASSES,” filed on Jan. 23, 2024 (Attorney Docket No. 4228.L76PRV), which is hereby incorporated by reference herein in its entirety.

### TECHNICAL FIELD

The present application relates generally to augmented reality (AR) devices, and more particularly to an optical support system for supporting optical elements within AR eyewear.

### BACKGROUND

AR devices, such as AR glasses, typically include a variety of optical components, including projectors, waveguides, displays, and other components. These components must be precisely aligned and maintained in position relative to each other to ensure the proper functioning of the AR device. Traditional AR devices often mount these optical elements in separate housings made of different materials, leading to tolerance and assembly variations between them. This can result in difficulties controlling and characterizing the optical constellations when the device is under load, such as when worn on different head sizes, or during user viewing of augmented content in an unstable or bumpy environment. Any misalignment between optical components can alter the axis along which projected light travels through the waveguides causing distortion or other issues with the augmented images.

Additionally, the direct bonding of projectors and waveguides to the device frame can transmit stresses from the arms to the frame and through the waveguide, causing degradation of the modulation transfer function (MTF). Deformation caused by transmitted stresses in assembly or use may put the waveguides and projectors out of calibration, causing further distortion or other issues with the augmented images. The current imaging housings for projectors are time-consuming and expensive to produce, typically requiring Computer Numerical Control (CNC) machining from aluminum.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings in which:

FIG. 1 is a perspective view of a wearable AR device, specifically AR glasses, showing the overall arrangement of the frame, arms, and optical components, in accordance with some examples.

FIG. 2 is an exploded view of an example optical support system, illustrating the monocular chassis and its associated components, including the waveguide, projector illumination sub-assembly, and various optical elements such as lenses and beam splitters, in accordance with some examples.

FIG. 3A is an assembled view of the optical support system from FIG. 2, showing the monocular chassis with the optical components mounted in place, in accordance with some examples.

FIG. 3B is another assembled view of the optical support system from FIG. 2, showing a different perspective of the monocular chassis with the optical components mounted in place, in accordance with some examples.

FIG. 4A illustrates the monocular chassis with integrated alignment features, including datum faces and a lens alignment bore, in accordance with some examples.

FIG. 4B shows the monocular chassis with a doublet lens positioned within the lens alignment bore, in accordance with some examples.

FIG. 4C depicts the monocular chassis with ae Light-Emitting Diode (LED) housing mounted to the rear of the chassis, in accordance with some examples.

FIG. 4D illustrates the monocular chassis with a pupil lens, half waveplate, and ghost image absorber positioned and secured in an alignment recess, in accordance with some examples.

FIG. 4E shows the monocular chassis with a Liquid Crystal on Silicon (LCoS) display panel floated into place and glued to alignment rails, in accordance with some examples.

FIG. 4F depicts the monocular chassis with the waveguide secured to the waveguide mount using pressure-sensitive adhesive (PSA) tape, in accordance with some examples.

FIGS. 5A-5B include, in FIG. 5B, a cross-sectional view of the optical support system taken along line 5B-5B of the pictorial view in FIG. 5A, illustrating a path of light through the optical components from the LEDs to the waveguide and into the user's field of view, in accordance with some examples.

FIG. 6 illustrates a method for assembling an optical support system for AR eyewear, in accordance with some examples.

FIG. 7 illustrates a method for assembling an optical support system for AR eyewear in accordance with some examples.

### DETAILED DESCRIPTION

Examples of the present disclosure seek to address the aforementioned challenges by providing an optical support system that integrates optical components such as a projector, waveguide, and other components into a single sub-assembly. This sub-assembly can be produced in left-handed and right-handed versions to make up a binocular pair. The binocular pair can be mounted to a spectacles frame to provide a pair of AR glasses. The optical support system is designed to protect the optical components and also to control the relationship between these elements when under load, thereby improving the optical performance and user experience.

In some examples, the optical support system includes a monocular chassis constructed to provide a unitary or integrated structure or monocoque configuration that allows for better control of tolerances between the optical elements and provides a more robust structure capable of withstanding the stresses encountered during normal use. In some examples, the monocular chassis may be considered to have monocoque type qualities in the sense that loads and stresses are borne throughout the structure rather than by a plurality of separate structures each bearing stress alone. The monocular, integrated configuration also facilitates independent module testing and re-workability, features not typically offered by current AR headset designs.

As the demand for AR devices increases, the inventors have recognized in additional aspects that there is a need for a design that can be scaled for mass production while maintaining high-quality optical alignment and reducing the impact of stresses on the optical components. This disclosure thus further relates to methods of manufacturing the monocular chassis that include injection molding techniques suitable for high-volume production. The chassis may be made from materials such as glass-filled polymers or other plastics with a low coefficient of thermal expansion (CTE) to ensure dimensional stability across a range of environmental conditions.

The foregoing and other features, utilities, and advantages will be apparent from the following more particular description of examples as illustrated in the accompanying drawings and described in the detailed description which follows.

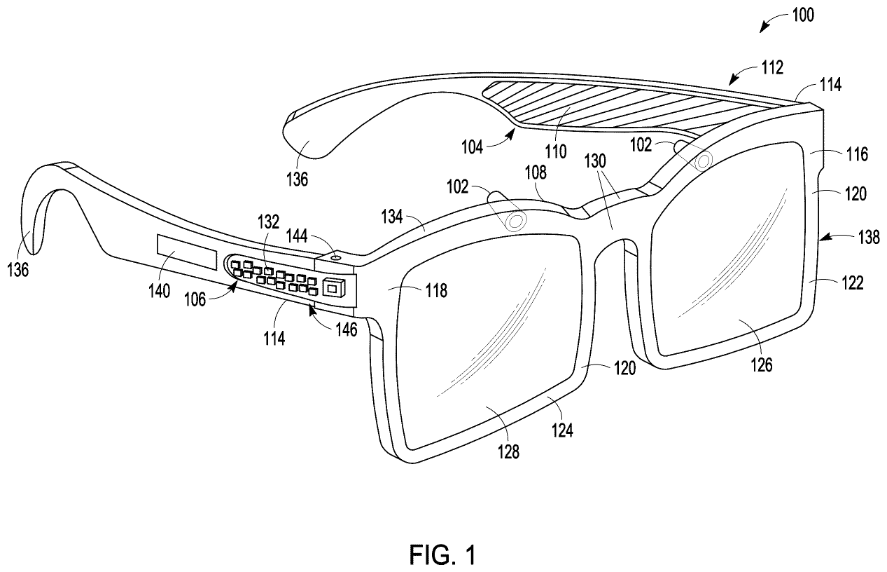

FIG. 1 shows a perspective view of a head-wearable user device, in this example shown as an AR eyewear device (e.g., the AR glasses 100), in accordance with some examples. The form factor of the AR glasses 100 is compact and space available for internal componentry is tight. The AR glasses 100, in this instance, can be worn to view augmented or virtual content displayed over real content visible in a content interaction system.

The example AR glasses 100 of FIG. 1 include a small frame 112 made from any suitable material such as plastic or metal, including any suitable shape memory alloy, as is known for ophthalmic eyewear. In one or more examples, the frame 112 includes a front piece 138, including a first or left (as worn by a user) optical element holder 122 (e.g., a display or lens holder) and a second or right (as worn by a user) optical element holder 124, connected by a nose piece or bridge 130. The front piece 138 additionally includes a left end portion 116 and a right end portion 118. A first or left optical element 126 and a second or right optical element 128 can be provided within or in association with respective left optical element holder 122 and right optical element holder 124. Each of the right optical element 128 and the left optical element 126 can be a projector, a lens, a display, a display assembly, a waveguide, or a combination of the foregoing. Further details of example optical elements (also termed optical components herein) are described further below. Any of the display assemblies and optical components disclosed herein can be provided in the AR glasses 100.

The frame 112 additionally includes a left arm or temple piece 104 and a right arm or temple piece 106 coupled to the respective left end portion 116 and the right end portion 118 of the front piece 138 by any suitable means such as at a folding hinge 144 (one folding hinge 144 on each side), so as to be coupled to the front piece 138, or rigidly or otherwise secured to the front piece 138 so as to be integral with the front piece 138. In one or more implementations, each of the temple piece 104 and the temple piece 106 includes a first portion 114 that is coupled to the respective left end portion 116 and right end portion 118 of the front piece 138 and any suitable second portion 136 for coupling to the ear of the user. In one or more examples, the front piece 138 can be formed from a single piece of material, so as to have a unitary or integral construction. In some examples, such as illustrated in FIG. 1, the entire frame 112 can be formed from a single piece of material so as to have a unitary or integral construction.

In some examples, some of the optical elements, such as the projector and waveguide and other components of the AR glasses 100 are mounted in a separately assembled optical support system. The optical support system includes a monocular chassis that integrates optical components such as the projector, waveguide, and other components into a single sub-assembly.

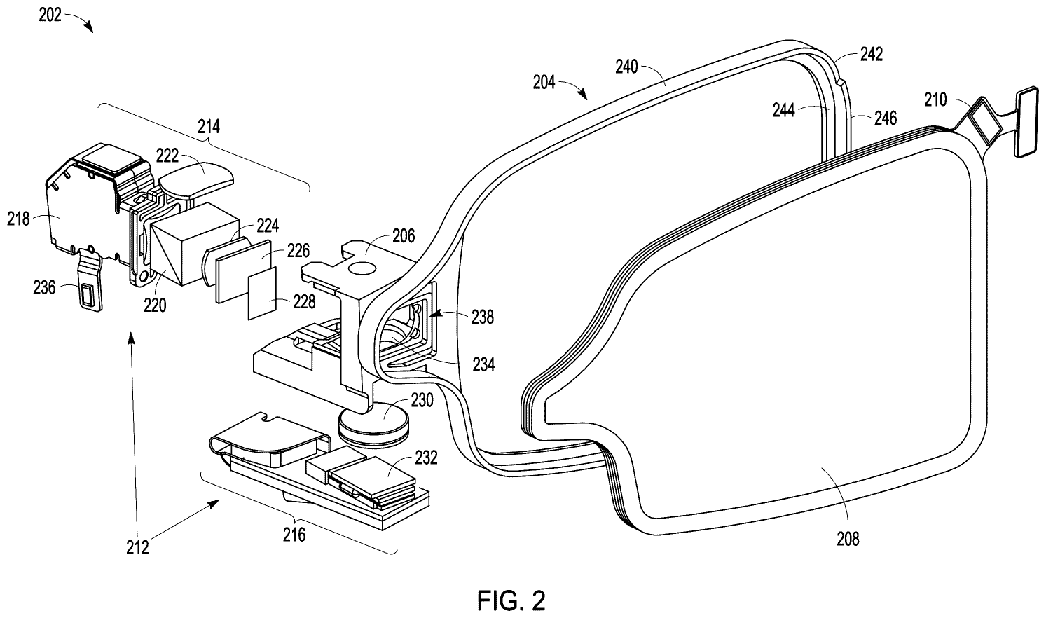

As mentioned above, the monocular chassis is constructed using a unitary or integrated structure or monocoque configuration that allows for better control of tolerances between the optical elements, in particular the projector and waveguide, and provides a more robust structure capable of withstanding the stresses encountered during normal use. In some examples, the optical support structure is provided as a sub-assembly in two versions, left handed and right handed, that make up a binocular pair and can be installed into the frame 112, for example into the first or left optical element holder 122 and the second or right optical element holder 124, respectively. An example optical support structure is described further below with reference to FIG. 2 and the following views. The example shown in that view is right handed as worn by a user.

In some examples, the AR glasses 100 can include a computing device, such as a computer 132, which can be of any suitable type so as to be carried by the frame 112 and, in one or more examples, of a suitable size and shape so as to be at least partially disposed in one of the temple pieces 104 and the temple pieces 106. In one or more examples, as illustrated in FIG. 1, the computer 132 is sized and shaped similar to the size and shape of one of the temple pieces 106 (e.g., or the temple piece 104), and is thus disposed almost entirely, if not entirely, within the structure and confines of such temple piece 106. In one or more examples, the computer 132 is disposed in both of the temple piece 104 and the temple piece 106 and flexible circuits connecting the two parts of the computer 132 pass through one (or typically both) of the folding hinges 144. The computer 132 can include one or more printed circuit boards (PCBs) and one or more hardware processors with memory, wireless communication circuitry, and a power source. In some examples, the computer 132 comprises low-power circuitry, high-speed circuitry, and a display processor. Various other examples may include these elements in different configurations or integrated together in different ways.

The computer 132 additionally includes a battery 110 or other suitable portable power supply. In some examples, the battery 110 is disposed in one of the temple pieces 104 or the temple piece 106. In the AR glasses 100 shown in FIG. 1, the battery 110 is shown as being disposed in left temple piece 104 and electrically coupled using the connection 134 to the remainder of the computer 132 disposed in the right temple piece 106. The AR glasses 100 can include a connector or port (not shown) suitable for charging the battery 110 accessible from the outside of frame 112, a wireless receiver, transmitter, or transceiver (not shown) or a combination of such devices.

In one or more implementations, the AR glasses 100 include cameras 102. Although two cameras 102 are depicted, other examples contemplate the use of a single or additional (i.e., more than two) cameras. In one or more examples, the AR glasses 100 include any number of input sensors or peripheral devices in addition to the cameras 102. The front piece 138 is provided with an outward facing, forward-facing, or front or outer surface 120 that faces forward or away from the user when the AR glasses 100 are mounted on the face of the user, and an opposite inward-facing, rearward-facing, or rear or inner surface 108 that faces the face of the user when the AR glasses 100 are mounted on the face of the user. Such sensors can include inwardly-facing video sensors or digital imaging modules, such as cameras that can be mounted on or provided within the inner surface 108 of the front piece 138 or elsewhere on the frame 112 so as to be facing the user, and outwardly-facing video sensors or digital imaging modules such as the cameras 102 that can be mounted on or provided with the outer surface 120 of the front piece 138 or elsewhere on the frame 112 so as to be facing away from the user. Such sensors, peripheral devices, or peripherals can additionally include biometric sensors, location sensors, or any other such sensors. In one or more implementations, the AR glasses 100 include a track pad 140 or other touch or sensory input device to receive navigational commands from the user. One or more track pads 140 may be provided at convenient locations for user interaction on one or both sides of the temple piece 104 and/or the temple piece 106. In some examples, non-optical components such as computer components, sensors, and/or cameras are included in or carried by the optical support system.

In some examples, a PCB of the computer 132 includes a flexible section 146. In some examples, the flexible section 146 is located at or adjacent to the folding hinge 144. More specifically, the flexible section 146 may be located in a region either side of or crossing the or each folding hinge 144. The flexible section 146 adjacent a folding hinge 144 may undergo a degree of bending, flexing, or movement when the arms or temple pieces 104 and 106 of the AR glasses 100 are opened and closed, for example.

FIG. 2 of the accompanying drawings shows components of an optical support system 202 in exploded view. The optical support system 202 includes a monocular chassis 204 that includes integrated alignment features 206 described more fully below. The optical support system 202 further comprises a waveguide 208. The waveguide 208 is supported in a waveguide mount 240. The waveguide mount 240 may be of ring shape as shown, having a part circular and/or part rectangular outlines, and in other examples may be provided in, or include, any one or more of a great variety of aesthetic circular, oval, and/or rectangular shapes. For ease of assembly, the shapes of the waveguide mount 240 of the optical support system 202 may be configured to comport with or accommodate a particular shape of the frame 112 of the AR glasses 100. The waveguide mount 240 includes features to accommodate and secure the waveguide 208 including, for example, a waveguide seat 244 and a peripheral wall 246, as shown.

In some examples, the waveguide 208 includes global dimming functionality. To this end, a global dimming connector 210 is provided. The global dimming connector 210 is locatable in a connector recess 242 provided in the waveguide mount 240. A user wearing the AR glasses 100 can operate a navigation button, in some examples, to dim the illumination of the augmented content displayed in the AR glasses in a universal or global manner depending on ambient conditions, for example.

The optical support system 202 includes and supports light projection means. These are shown generally in the illustrated example as the projector system 212, or light engine. The projector system 212 generally includes an illumination sub-assembly 214 and an imaging sub-assembly 216.

The illumination sub-assembly 214 includes an LED housing 218, a polarizing beam splitter (PBS) 220, and a mirror 222 mounted in association with the PBS 220. The LED housing 218 includes a power connector 236. At an exit side of the PBS 220, a pupil lens 224 is provided. A half waveplate 226 is positioned adjacent to the pupil lens 224 to assist in processing the light passing through the pupil lens 224. In some examples, a ghost image absorber 228 is provided adjacent the pupil lens 224 to capture stray light or unwanted double images.

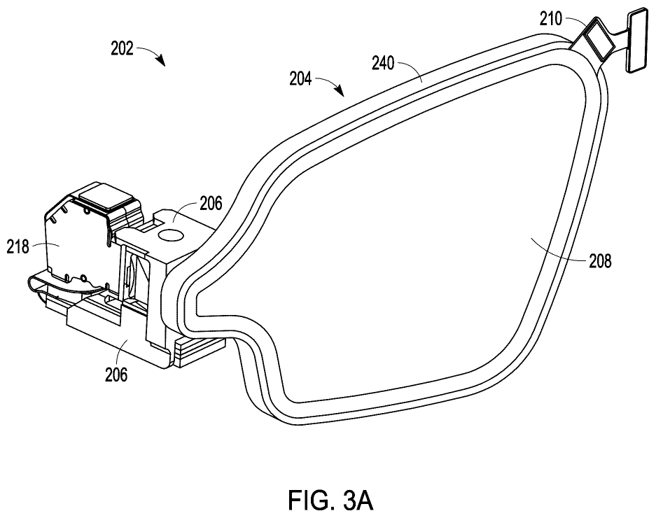

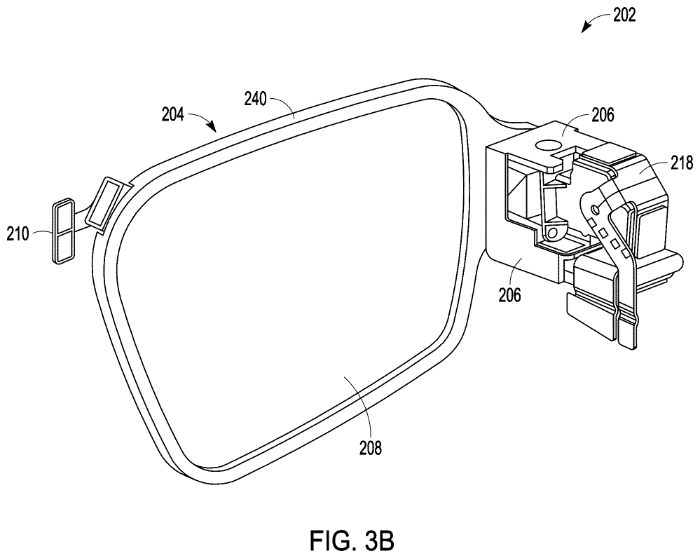

The imaging sub-assembly 216 of the projector system 212 includes an imaging lens such as a doublet lens 230 and a display panel such as a Liquid Crystal over Silicon (LCoS) display panel 232. The doublet lens 230 is received in and positioned by a lens alignment bore 234 as described more fully below. FIG. 3A and FIG. 3B show these components of the optical support system 202 in assembled form.

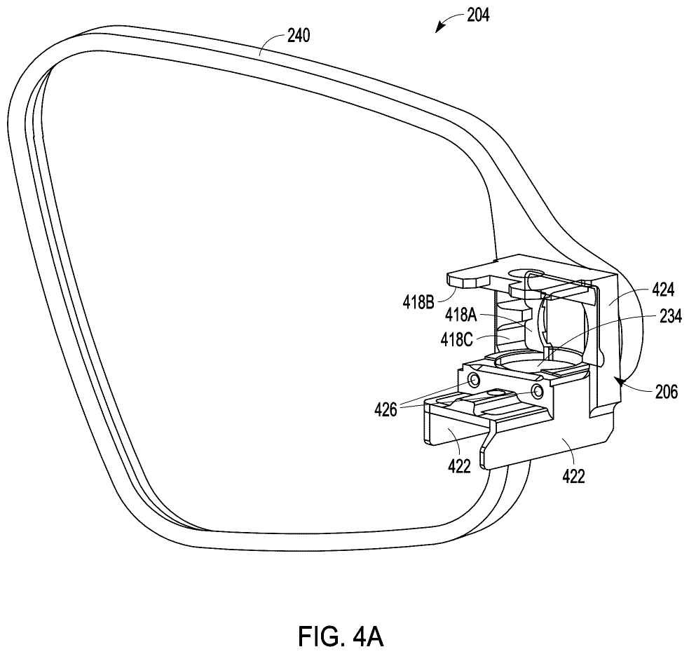

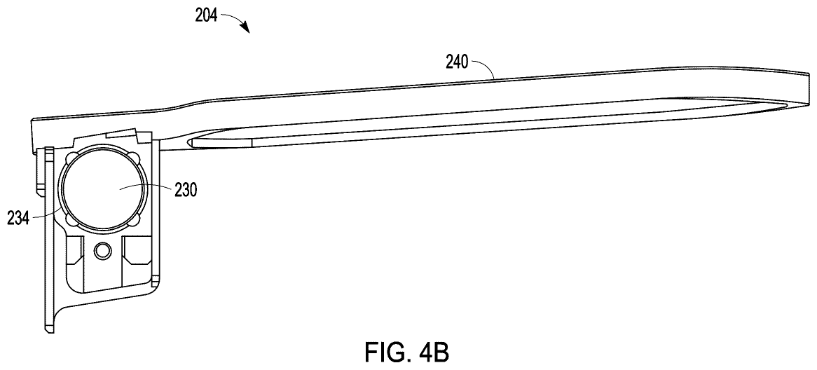

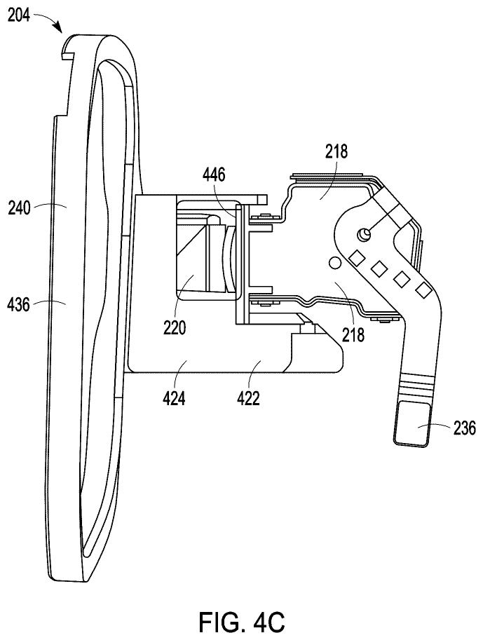

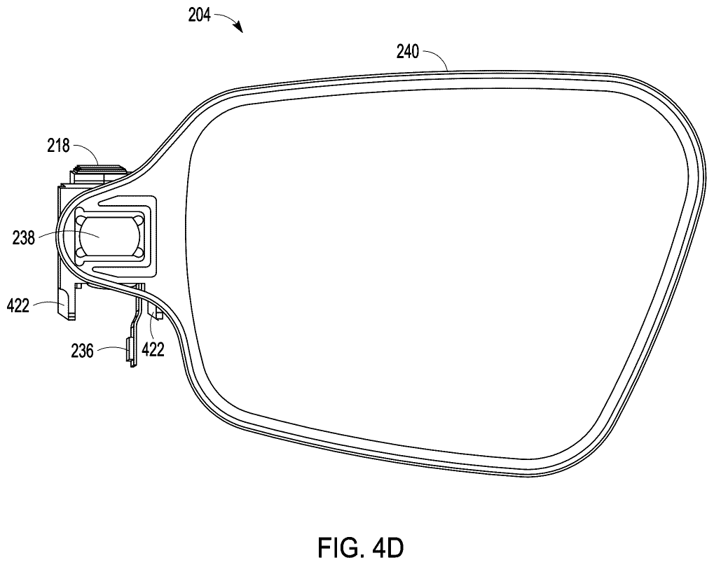

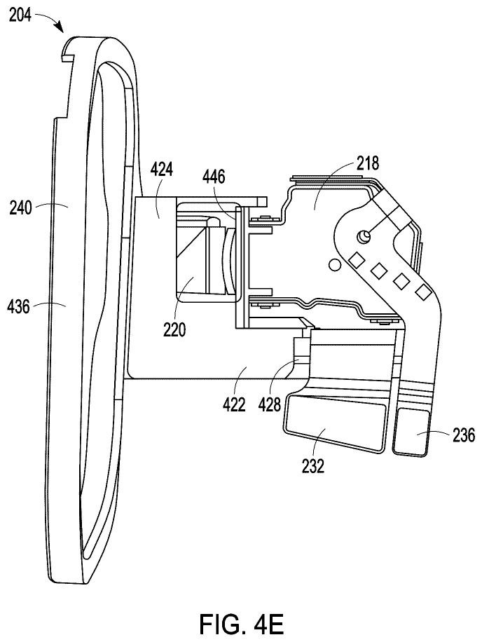

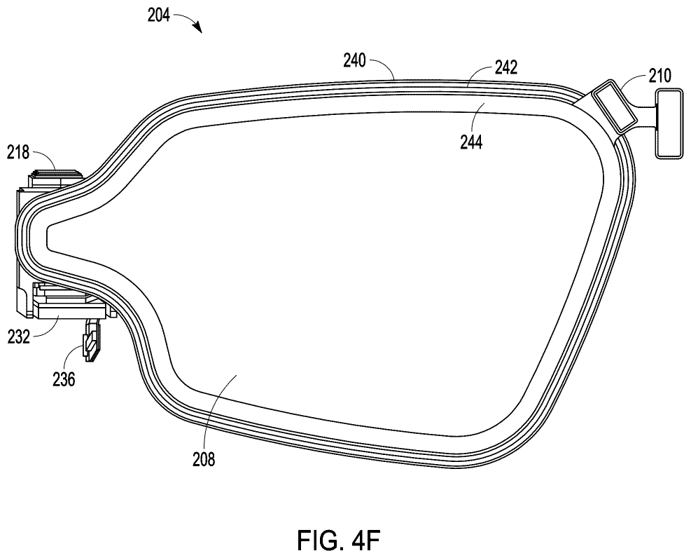

An example assembly of the components of the optical support system 202 is now described with reference to FIG. 4A-FIG. 4F. The integrated alignment features 206 of the monocular chassis 204 enable the components of the illumination sub-assembly 214 and the imaging sub-assembly 216 to be positioned conveniently in precise alignment with one another to address some of the problems and challenges discussed further above.

With reference to FIG. 4A, the integrated alignment features 206 will be seen to comprise one or more internal datum faces 418 against which the PBS 220 can sit in abutment to be correctly positioned and secured relative to the monocular chassis 204 and other optical components of the optical support system 202. The PBS 220 may be secured to the datum faces 418 by adhesive, in some examples. Other securement options are possible. By means of the integrally provided datum faces 418, the PBS 220 of the illumination sub-assembly 214 can be correctly positioned and oriented with respect to the imaging sub-assembly 216 and, ultimately, the waveguide 208 (when positioned in the waveguide mount 240) to process and present consistent images viewed by the user. In the illustrated example, the datum faces 418 of the integrated alignment features 206 include X, Y, and Z surfaces (labelled as 418A, 418B and 418C) defined by internal horizontal and vertical (in the view) walls or surfaces of an integral positioning enclosure 424.

The integrated alignment features 206 of the optical support system 202 further comprise the lens alignment bore 234 mentioned above and at least one alignment rail 422 (in this case, a pair of alignment rails 422 extending parallel to each other as shown). The pair of alignment rails 422 serve to align and support other components of the imaging sub-assembly 216 as described below. A pair of positioning dowel pin holes 426 are provided adjacent the alignment rails 422. These dowel pin holes 426 can receive and secure guiding dowel pins 428 pins provided on the LCoS display panel 232 as described with reference to FIG. 4E below.

Thus, the monocular chassis 204 can support and align critical optical components within an AR device. The chassis 204 includes integrated alignment features 206, which are integral to the monocular chassis and are specifically configured to facilitate precise positioning and securement of the optical elements. The alignment features, including the guiding dowel pins 428, respectively provide a reference surface and guide means for the PBS 220 and other components helping to ensure their correct orientation and alignment relative to the optical axis of the AR device.

In FIG. 4B the doublet lens 230 of the imaging sub-assembly 216 is inserted into the lens alignment bore 234 to be held there in precise alignment with the monocular chassis 204 and other optical components of the illumination sub-assembly 214. In some examples, the lens alignment bore 234 is precision-machined or molded into the monocular chassis 204 to receive the doublet lens 230, which is a critical component of the imaging sub-assembly. The precise fit between the doublet lens and the lens alignment bore ensures that the lens is held in the correct position to focus and direct light towards the display panel.

In FIG. 4C, the LED housing 218 is mounted to the rear of the monocular chassis 204. In the illustrated example, the LED housing 218 is positioned by and secured to an external datum face 446 of the integral positioning enclosure 424. Thus, the LED housing 218 is aligned and secured to the monocular chassis 204 by the one or more external datum faces that are part of the integral positioning enclosure 424 and monocular chassis 204. This ensures that the LED housing 218 is correctly positioned and aligned to emit light towards the PBS 220 and through the optical system.

In FIG. 4D, the pupil lens 224, the half waveplate 226, and the ghost image absorber 228 are positioned and secured in precise locations in an alignment recess 238 provided as an integrated alignment feature 206 in the monocular chassis 204. The alignment recess 238 is provided in transverse relationship with the lens alignment bore 234 for positioning the pupil lens 224 of the illumination sub-assembly 214 of the projector system 212. In some examples, the transverse relationship between the doublet lens 230 and the pupil lens 224 can be established and stabilized very precisely to assist in ensuring consistently aligned cooperation of the optical components of the illumination sub-assembly 214 with the optical components of the imaging sub-assembly 216 and seek to avoid issues arising from birefringence, for example. The alignment recess 238 is designed to hold these components in a stacked arrangement, maintaining their precise alignment relative to each other and to the rest of the optical system.

In FIG. 4E, the LCOS display panel 232 is floated or otherwise moved into place robotically to focus an image presented by the illumination sub-assembly 214 in the LCOS display panel 232 and is glued at that location to the alignment rails 422 of the monocular chassis 204. The guiding dowel pins 428 may be inserted into the dowel pin holes 426 for additional positioning guidance and security of attachment in that precise location and orientation of the LCOS display panel 232. A position of the LCOS display panel 232 when fixed to the alignment rails 422 is thus based, in some examples, on a focusing of an image presented by the projector, but other location options are possible. The alignment rails, along with positioning dowel pin holes and guiding dowel pins, ensure that the display panel is secured in the exact location required for optimal performance.

In FIG. 4F, the waveguide 208 is secured to the waveguide mount 240 of the monocular chassis 204 by PSA tape. In some examples, the waveguide 208 is secured on the waveguide seat 244 within the peripheral wall 246 somewhat movably or resiliently relative to the waveguide mount 240 with PSA tape configured to decouple the waveguide 208 at least in part from stresses imparted by the monocular chassis 204 or the frame 112 of the AR glasses 100 in use. In some examples, the optical support system 202 is provided as one of a binocular pair of optical support systems. The binocular pair may include left and right hand versions of the optical support systems. The binocular pair of optical support systems can be mounted to the frame 112 of the AR glasses 100 by PSA tape configured to decouple the binocular pair of optical support systems at least in part from stresses imparted by the frame of the AR glasses 100 in use.

Thus, FIG. 4F depicts the final assembly step where the waveguide 208 is attached to the waveguide mount 240 of the monocular chassis 204. The PSA tape allows for some degree of movement or repositioning to accommodate stress and prevent distortion. The PSA tape provides a secure yet flexible bond between the waveguide 208 and the monocular chassis 204, helping to ensure that the waveguide 208 remains correctly aligned with the LED housing 218 under varying conditions.

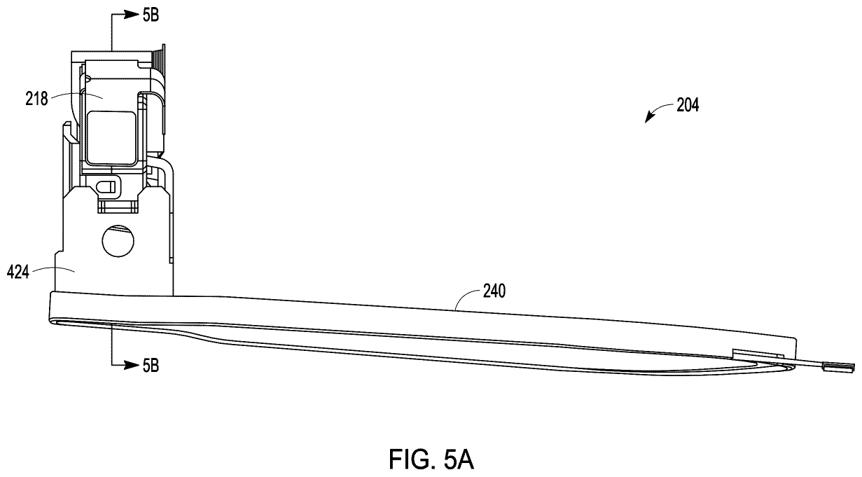

In FIG. 5A, the part-sectional view in FIG. 5B is taken at the line 5B-5B of the assembled optical support system 202 shown on the left of the view. In the part-sectional view, a red/blue LED 526 sits at the top of the LED housing 218 based on the orientation of the view. A green LED 528 sits at the rear of the LED housing 218. The red/blue LED 526 and the green LED 528 are powered up in use and emit light that passes through a number of respective lenses 538 before encountering a dichroic wedge 530. The dichroic wedge 530 has a first wedge 548 and a second wedge 550.

The dichroic wedge 530 has a front face 532 that is inclined to the incident red/blue light emitted by the red/blue LED 526 such that this causes the red/blue light to be reflected to the right in the view. A rear face 534 of the dichroic wedge 530 is inclined to the incident green light emitted by the green LED 528 such that this allows the green light to pass through the dichroic wedge 530 in the same direction. The red, blue, and green light enters and is polarized by a multi-lens array 542. In some examples, the red, blue, and green light is timed sequentially to illuminate the LCOS display panel 232 with the combination of the red, blue, and green light occurring at the eye with the brain constructing a full color image through the persistence of light. In some examples, if the colors of light were combined prior to the LCOS display panel 232, a full color image would not be formed.

From the multi-lens array 542, the polarized light passes through a relay lens 544 and enters the PBS 220. The first wedge 548 of the PBS 220 causes the combined, polarized light to be reflected up in the view to the mirror 222 where it is reflected back down off the mirror 222 to pass through both the first wedge 548 and the second wedge 550 and enter and appear in the LCOS display panel 232 as an image focused by the doublet lens 230. In some examples, the focused image is established and fixed by locating the LCoS display panel 232 on the alignment rail 422 correctly by a robot, as discussed above.

The focused image is then reflected back up from the LCOS display panel 232 through the first wedge 548 of the PBS 220 and then 90 degrees out to the right (in the view) through the second wedge 550 of the PBS 220, through the pupil lens 224 and the half waveplate 226 to the end of the projector system 212. Here, the focused image enters the waveguide 208 to be diffracted through nanostructure gratings along the waveguide 208 and into the user's field of view (FOV). The pupil lens 224 may function as an input coupler with the input light being diffracted into the waveguide 208 by an input grating that directs light via total internal reflection within the waveguide in the direction of an output grating that diffracts light out of the waveguide at the distal end of the waveguide 208 towards the eye of a user. It will be appreciated that the various components just described can be positioned conveniently by the monocular chassis 204 and integrated alignment features 206 during assembly, and held securely in precise alignment in their desired positions by the optical support system 202 and its various alignment features.

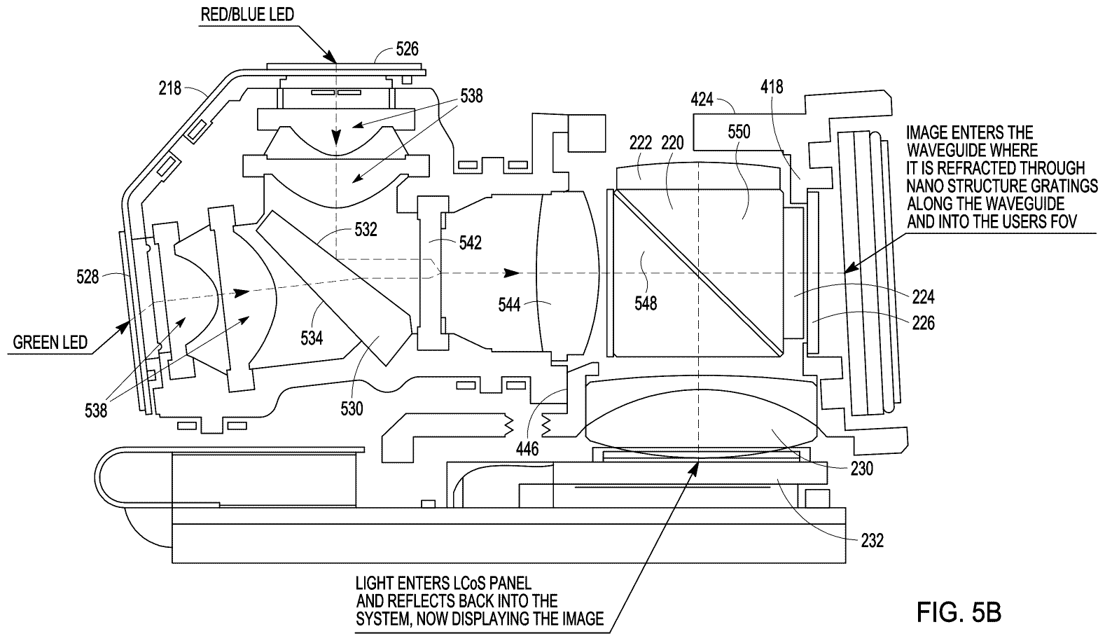

The present disclosure also includes method examples. With reference to FIG. 6, a method for assembling an optical support system for AR eyewear comprises, in operation 602, providing a monocular chassis. In operation 604, method 600 includes aligning and securing a projector system and a waveguide within the monocular chassis using integrated alignment features of the monocular chassis. In some examples, providing the monocular chassis includes injection molding the monocular chassis to form the integrated alignment features.

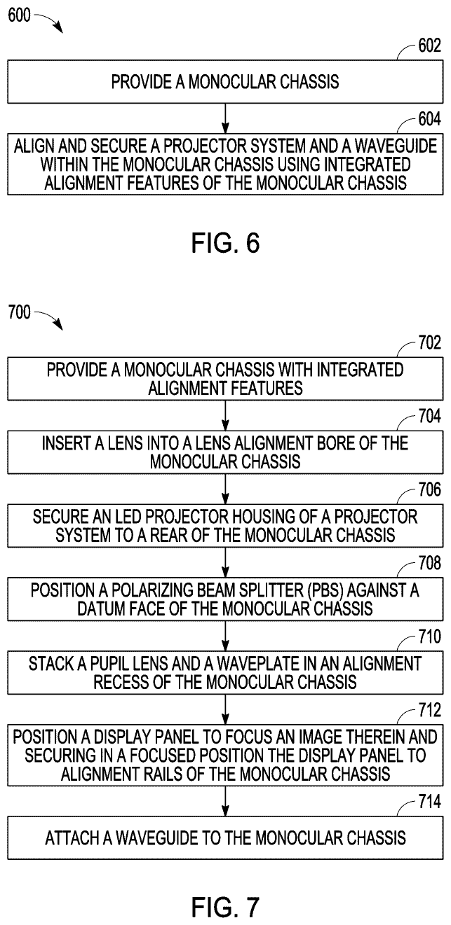

With reference to FIG. 7, a method 700 for assembling an optical support system for AR eyewear comprises, in operation 702, providing a monocular chassis with integrated alignment features. In operation 704, method 700 includes inserting a lens into a lens alignment bore of the monocular chassis. In operation 706, method 700 includes securing an LED housing of a projector system to a rear of the monocular chassis. In operation 708, method 700 includes positioning a PBS against a datum face of the monocular chassis. In operation 710, method 700 includes stacking a pupil lens and a waveplate in an alignment recess of the monocular chassis. In operation 712, method 700 includes positioning a display panel to focus an image therein and securing in a focused position the display panel to alignment rails of the monocular chassis. In operation 714, method 700 includes attaching a waveguide to the monocular chassis.

The method may also include where positioning a display panel to focus an image therein includes robotically positioning the display panel during an assembly of the optical support system. The method may also include where the LED housing is aligned and secured to the monocular chassis using an external datum face of the monocular chassis. The method may also include where the polarizing beam splitter (PBS) is secured to the datum face by adhesive. The method may also include where the pupil lens and the half waveplate are positioned within the alignment recess in a transverse relationship with the lens inserted into the lens alignment bore. The method may also include where the display panel is positioned and focused by a robot based on an image presented by the projector system. The method may also include where the waveguide is secured to the monocular chassis in a manner that allows for movement relative to the monocular chassis to accommodate stress. The method may also include where the optical support system is part of a binocular pair of optical support systems, and the method further includes mounting the binocular pair to a frame of the AR eyewear. The method may also include decoupling the mounted binocular pair of optical support systems from stresses imparted by the frame of the AR eyewear using PSA tape.

Although the described flow diagrams herein show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof.

The present disclosure thus seeks to provide an optical support system for AR eyewear that significantly enhances the alignment, protection, and structural integrity of the optical components used in such devices. Central to some examples is a monocular chassis that employs a unitary or monocoque construction, integrating multiple optical elements into a single, cohesive sub-assembly. This configuration can offer several advantages, including improved tolerance control between the optical elements and increased resistance to stresses encountered during normal use.

The monocular chassis is equipped with integrated alignment features that ensure the precise positioning of the projector, waveguide, and other optical components, which is critical for maintaining the quality of the augmented visual experience. The alignment features are designed to accommodate the components in a manner that mitigates the risk of optical misalignment and distortion.

To accommodate the demands of mass production, the monocular chassis is fabricated using materials with, in some examples, a low coefficient of thermal expansion and is produced through an injection molding process. This allows for the production of the chassis at scale while maintaining the high precision required for the optical alignments.

Furthermore, the disclosure includes examples for decoupling the projector from stresses transmitted by the eyewear frame, which can be useful for preventing image distortion that can occur due to frame flexing. The waveguide is attached to the chassis using PSA tape, which provides a secure yet flexible bond, allowing for some movement and repositioning to accommodate stress without compromising the alignment of the optical components. Overall, the disclosure provides a scalable, robust, and precise optical support system that enhances the manufacturing process and user experience of AR eyewear.

### Examples

Example 1. An optical support system for augmented reality (AR) eyewear, comprising: a monocular chassis configured to support a projector and a waveguide of the AR eyewear, the monocular chassis being of a unitary construction and including as part of the monocular chassis: one or more integrated alignment features for positioning the projector relative to the waveguide in the AR eyewear; and a waveguide mount for mounting the waveguide to the monocular chassis.

Example 2. The optical support system of example 1, wherein the one or more integrated alignment features include one or more datum faces for positioning an illumination sub-assembly of the projector relative to the monocular chassis.

Example 3. The optical support system of example 2, wherein the one or more datum faces are configured to position a polarizing beam splitter (PBS) of the illumination sub-assembly of the projector with the PBS sitting in abutment with the one or more datum faces.

Example 4. The optical support system of example 2 or example 3, wherein the one or more datum faces position the illumination sub-assembly of the projector relative to an imaging sub-assembly of the projector.

Example 5. The optical support system of example 4, wherein the one or more integrated alignment features include a lens alignment bore for positioning an imaging lens adjacent a display panel of the imaging sub-assembly of the projector.

Example 6. The optical support system of example 5, wherein the imaging lens is a doublet lens.

Example 7. The optical support system of example 5, wherein the monocular chassis further includes an alignment recess, in transverse relationship with the lens alignment bore, for positioning a pupil lens of the illumination sub-assembly of the projector.

Example 8. The optical support system of example 7, wherein the alignment recess is further configured to position a waveplate of the illumination sub-assembly of the projector.

Example 9. The optical support system of example 8, wherein the waveplate is located adjacent the pupil lens when positioned.

Example 10. The optical support system of example 5, wherein the one or more integrated alignment features include at least one alignment rail for holding the display panel fixed in the optical support system.

Example 11. The optical support system of example 10, wherein a position of the display panel when fixed to the at least one alignment rail is based on a focusing of an image presented by the projector.

Example 12. The optical support system of example 11, wherein the display panel is moved to the position by a robot during an assembly of the optical support system.

Example 13. The optical support system of any one of examples 1-12, wherein the waveguide includes a global dimming connector.

Example 14. The optical support system of any one of examples 1-13, wherein the waveguide is secured to the waveguide mount with adhesive tape.

Example 15. The optical support system of example 14, wherein the waveguide is secured movably relative to the waveguide mount with pressure-sensitive adhesive (PSA) tape configured to decouple the waveguide at least in part from stresses imparted by the monocular chassis or a frame of the AR eyewear.

Example 16. The optical support system of example 15, wherein the optical support system is provided as one of a binocular pair of optical support systems.

Example 17. The optical support system of example 16, wherein the binocular pair of optical support systems is mounted to the frame of the AR eyewear by PSA tape configured to decouple the binocular pair of optical support systems at least in part from stresses imparted by the frame of the AR eyewear.

Example 18. An augmented reality (AR) eyewear system, comprising: a frame configured to be worn by a user; an optical support system according to example 1 mounted within the frame; and a projector and a waveguide positioned and supported by the monocular chassis of the optical support system.

Example 19. A method for assembling an optical support system for augmented reality (AR) eyewear, comprising: providing a monocular chassis; and aligning and securing a projector system and a waveguide within the monocular chassis using integrated alignment features of the monocular chassis.

Example 20. The method of example 19, wherein providing the monocular chassis includes injection molding the monocular chassis to form the integrated alignment features.

Example 21. A method for assembling an optical support system for augmented reality (AR) eyewear, the method comprising: providing a monocular chassis with integrated alignment features; inserting a lens into a lens alignment bore of the monocular chassis; securing a Light-Emitting Diode (LED) housing of a projector system to a rear of the monocular chassis; positioning a polarizing beam splitter (PBS) against a datum face of the monocular chassis; stacking a pupil lens and a waveplate in an alignment recess of the monocular chassis; positioning a display panel to focus an image therein and securing in a focused position the display panel to alignment rails of the monocular chassis; and attaching a waveguide to the monocular chassis.

Example 22. The method of example 21, wherein positioning a display panel to focus an image therein includes robotically positioning the display panel during an assembly of the optical support system.

Example 23. The method of example 21 or example 22, wherein the LED housing is aligned and secured to the monocular chassis using an external datum face of the monocular chassis.

Example 24. The method of any one of examples 21-23, wherein the PBS is secured to the datum face by adhesive.

Example 25. The method of any one of examples 21-24, wherein the pupil lens and the waveplate are positioned within the alignment recess in a transverse relationship with the lens inserted into the lens alignment bore.

Example 26. The method of one of examples 21-25, wherein the display panel is positioned and focused by a robot based on an image presented by the projector system.

Example 27. The method of any one of examples 21-26, wherein the waveguide is secured to the monocular chassis in a manner that allows for movement relative to the monocular chassis to accommodate stress.

Example 28. The method of any one of examples 21-27, wherein the optical support system is part of a binocular pair of optical support systems, and the method further comprises mounting the binocular pair to a frame of the AR eyewear.

Example 29. The method of example 28, further comprising decoupling the mounted binocular pair of optical support systems from stresses imparted by the frame of the AR eyewear using PSA tape.

While the above is a complete description of some examples of the inventive subject matter, various alternatives, modifications, and equivalents may be used. Therefore, the above description should not be taken as limiting the scope of the inventive subject matter which is defined by the appended claims.

What is claimed is:

1. An optical support system for augmented reality (AR) eyewear, comprising:
a monocular chassis configured to support a projector and a waveguide of the AR eyewear, the monocular chassis being of a unitary construction and including as part of the monocular chassis:
one or more integrated alignment features for positioning the projector relative to the waveguide in the AR eyewear; and
a waveguide mount for mounting the waveguide to the monocular chassis.

2. The optical support system of claim 1, wherein the one or more integrated alignment features include one or more datum faces for positioning an illumination sub-assembly of the projector relative to the monocular chassis.

3. The optical support system of claim 2, wherein the one or more datum faces are configured to position a polarizing beam splitter (PBS) of the illumination sub-assembly of the projector with the PBS sitting in abutment with the one or more datum faces.

4. The optical support system of claim 2, wherein the one or more datum faces position the illumination sub-assembly of the projector relative to an imaging sub-assembly of the projector.

5. The optical support system of claim 4, wherein the one or more integrated alignment features include a lens alignment bore for positioning an imaging lens adjacent a display panel of the imaging sub-assembly of the projector.

6. The optical support system of claim 5, wherein the imaging lens is a doublet lens.

7. The optical support system of claim 5, wherein the monocular chassis further includes an alignment recess, in transverse relationship with the lens alignment bore, for positioning a pupil lens of the illumination sub-assembly of the projector.

8. The optical support system of claim 7, wherein the alignment recess is further configured to position a waveplate of the illumination sub-assembly of the projector.

9. The optical support system of claim 8, wherein the waveplate is located adjacent the pupil lens when positioned.

10. The optical support system of claim 5, wherein the one or more integrated alignment features include at least one alignment rail for holding the display panel fixed in the optical support system.

11. The optical support system of claim 10, wherein a position of the display panel when fixed to the at least one alignment rail is based on a focusing of an image presented by the projector.

12. The optical support system of claim 11, wherein the display panel is moved to the position by a robot during an assembly of the optical support system.

13. The optical support system of claim 1, wherein the waveguide includes a global dimming connector.

14. The optical support system of claim 1, wherein the waveguide is secured to the waveguide mount with adhesive tape.

15. The optical support system of claim 14, wherein the waveguide is secured movably relative to the waveguide mount with pressure-sensitive adhesive (PSA) tape configured to decouple the waveguide at least in part from stresses imparted by the monocular chassis or a frame of the AR eyewear.

16. The optical support system of claim 15, wherein the optical support system is provided as one of a binocular pair of optical support systems.

17. The optical support system of claim 16, wherein the binocular pair of optical support systems is mounted to the frame of the AR eyewear by PSA tape configured to decouple the binocular pair of optical support systems at least in part from stresses imparted by the frame of the AR eyewear.

18. An augmented reality (AR) eyewear system, comprising:
a frame configured to be worn by a user;
an optical support system according to claim 1 mounted within the frame; and
a projector and a waveguide positioned and supported by the monocular chassis of the optical support system.

19. A method for assembling an optical support system for augmented reality (AR) eyewear, comprising:
providing a monocular chassis; and
aligning and securing a projector system and a waveguide within the monocular chassis using integrated alignment features of the monocular chassis.

20. The method of claim 19, wherein providing the monocular chassis includes injection molding the monocular chassis to form the integrated alignment features.

21. A method for assembling an optical support system for augmented reality (AR) eyewear, the method comprising:
providing a monocular chassis with integrated alignment features;
inserting a lens into a lens alignment bore of the monocular chassis;
securing a Light-Emitting Diode (LED) housing of a projector system to a rear of the monocular chassis;
positioning a polarizing beam splitter (PBS) against a datum face of the monocular chassis;
stacking a pupil lens and a waveplate in an alignment recess of the monocular chassis;
positioning a display panel to focus an image therein and securing in a focused position the display panel to alignment rails of the monocular chassis; and
attaching a waveguide to the monocular chassis.

22. The method of claim 21, wherein positioning a display panel to focus an image therein includes robotically positioning the display panel during an assembly of the optical support system.

23. The method of claim 21, wherein the LED housing is aligned and secured to the monocular chassis using an external datum face of the monocular chassis.

24. The method of claim 21, wherein the PBS is secured to the datum face by adhesive.

25. The method of claim 21, wherein the pupil lens and the waveplate are positioned within the alignment recess in a transverse relationship with the lens inserted into the lens alignment bore.

26. The method of claim 21, wherein the display panel is positioned and focused by a robot based on an image presented by the projector system.

27. The method of claim 21, wherein the waveguide is secured to the monocular chassis in a manner that allows for movement relative to the monocular chassis to accommodate stress.

28. The method of claim 21, wherein the optical support system is part of a binocular pair of optical support systems, and the method further comprises mounting the binocular pair to a frame of the AR eyewear.

29. The method of claim 28, further comprising decoupling the mounted binocular pair of optical support systems from stresses imparted by the frame of the AR eyewear using PSA tape.
